(19) United States
(12) Patent Application Publication
(10) Pub. No.: US 2003/0146973 A1
(43) Pub. Date: Aug. 7, 2003

(54) 3D stereoscopic enabling methods for a monoscopic application to support 3D stereoscopic imaging

(76) Inventors: David C. Swift, Cortlandt Manor, NY (US); Joshua Ong, Pomona, NY (US); Michael L. Roche, Pomona, NY (US)

Correspondence Address: Gerow D. Brill, Reveo, Inc., 85 Executive Blvd., Elmsford, NY, 10523, US

(21) Appl. No.: 10/293,526

(22) Filed: Nov. 12, 2002

Related U.S. Application Data
(60) Provisional application No. 60/345,406, filed on Nov. 9, 2001.

(51) Int. Cl. H04N 15/00

(52) U.S. Cl. 348/51; 348/42; 382/154

(57) ABSTRACT

The present invention addresses the problem of converting existing 2D applications into 3D stereoscopic compatible applications using a 3D enabling solution. This enabling solution results in a 3D stereoscopic software application with the following characteristics and benefits: provides stereoscopic features using a familiar interface; allows a large existing base of 2D applications to be converted to 3D; reduces development time and cost since core features are already provided by the existing 2D application; makes it easy to create 3D stereoscopic content using well known tools; and ease of display using a variety of 3D viewing methods. The present invention is realized using a combination of 3D enabling methods. These methods include: Plug-In; Compiled or Interpreted program language extension; Com/Active-X/DLL/Library Control; External Application; Custom Hack or Patch; Platform modification. By combining these methods, a more unified method of converting a 2D application into a 3D stereoscopic application can be achieved. The apparatus and method of implementation of the 2D to 3D enabling in conjunction with a display device may be accomplished using an article of manufacture, computer program product program or program storage device having a computer usable medium having computer readable program code embodied therein for converting existing 2D applications into 3D stereoscopic compatible applications.

### RELATED APPLICATIONS

The present application claims priority to U.S. provisional application serial No. 60/345,406 filed on Nov. 9, 2001, entitled “3D Stereoscopic Enabling Methods for a Monoscopic Application to Support 3D Stereoscopic Imaging”, which is hereby incorporated by reference in its entirety.

### FIELD OF THE INVENTION

The present invention relates generally to 3D stereoscopic enabling methods for a monoscopic application to support 3D stereoscopic imaging and in particular to converting existing 2D applications into 3D stereoscopic compatible applications using a 3D enabling solution.

### BACKGROUND OF THE INVENTION

3D stereoscopic imaging allows true depth information to be displayed on special hardware devices and/or by using special viewing devices. There are many 3D stereoscopic imaging solutions available but they are not pervasive in the display industry due to lack of creation and display software for stereoscopic 3D. Specific versions of software to support 3D stereoscopic imaging can be expensive to develop and would require users to switch from existing 2D applications to new 3D stereoscopic ones. Instead, if an enabling method is provided to convert existing 2D applications into 3D stereoscopic applications then there will be an easier adoption cycle for the end users since users will already be familiar with the 2D application.

In order for a 3D enabling solution to be pervasive, it must provide a similar interface for the 3D stereoscopic features as it does for the normal 2D features. The solution also needs to build on the 2D functionality. For example, 3D stereoscopic text in a presentation program needs to support the basic 2D text functionality such as font changing and editing. The 2D interfaces need to be accessible within the 3D interfaces to provide the ability to update the original 2D data items using familiar interfaces. The 3D enabling solution must also provide stereoscopic visualization during the authoring or creation process.

There have been several attempts to create 3D stereoscopic applications by providing custom plug-ins but these solutions suffer from the following problems:

Many only support one 3D stereoscopic format making them incompatible with most of the 3D stereoscopic display systems. Universal display support is required to make these solutions pervasive.

To the best of the applicants' knowledge, no existing solutions will allow the user to view the data in 3D during authoring. They only support 3D during play back or viewing mode. This requires the user to follow a two-step process (create and then view) that is different than the 2D methods of authoring and viewing simultaneously.

Once the user converts to the 3D mode, many of the solutions do not allow the user to view or edit in the original 2D mode without first removing the 3D feature.

Many suffer from poor image quality.

An example of an existing 3D software system is Stereo Stage Now from Arisawa Manufacturing Company in Japan which provides a non-standard interface to make limited 3D stereoscopic PowerPoint® images (Power Point is a Microsoft Office software application).

2D to 3D conversion systems or methods is needed that overcome these cited difficulties.

### SUMMARY OF THE INVENTION

The present invention addresses the problem of converting existing 2D applications into 3D stereoscopic compatible applications using a 3D enabling solution. This enabling solution results in a 3D stereoscopic software application with the following characteristics and benefits:

Provides stereoscopic features using a familiar interface.

Allows a large existing base of 2D applications to be converted to 3D.

Reduces development time and cost since core features are already provided by the existing 2D application.

This invention makes is easy to create 3D stereoscopic content using well known tools.

Ease of display using a variety of 3D viewing methods.

The present invention is realized using a combination of 3D enabling methods. These methods are:

Plug-In

Compiled or Interpreted program language extension

Com/Active-X/DLL/Library Control

External Application

Custom Hack or Patch

Platform modification

By combining one or more of these methods, a more unified method of converting a 2D application into a 3D stereoscopic application can be achieved. Of course, it may be possible to create a 3D stereoscopic application using only one of these methods.

Example applications that can support this enabling method invention are:

Presentation systems like Microsoft Power Point

Multi-media authoring and presentation systems like Macromedia Director

Animation and media authoring and display systems like Shockwave, Flash, and Flash Player

Geometry based creation and viewing systems like 3D Studio Max, Shockwave, Viewpoint viewer, etc.

The apparatus and method of implementation of the 2D to 3D enabling in conjunction with a display device is accomplished by using an article of manufacture, computer program product program or program storage device having a computer usable medium having computer readable program code embodied for converting existing 2D applications into 3D stereoscopic compatible applications.

### BRIEF DESCRIPTION OF THE DRAWINGS

For a more complete understanding of invention, the following detailed description of the Invention should be read in conjunction with the accompanying Drawings wherein:

FIG. 1 illustrates a system block diagram showing the interaction of the creation, editing, rendering and display functions in a typical 2D application;

FIG. 2 illustrates the same 2D system from FIG. 1 with the addition of two blocks that constitute the 3D stereoscopic enabling system;

FIG. 3 illustrates a system similar to the system of FIG. 2 except that the 3D Authoring Block has been removed;

FIG. 4 illustrates the standalone embedded object technique for enabling a 2D application to utilize stereoscopic content;

FIG. 5 illustrates using a standalone User-Interface Extension to stereoscopically enable a 2D Application;

FIG. 6 illustrates a mechanism that combines the two previous methods to provide greater support for stereoscopic display; and.

FIG. 7 illustrates a Block Diagram for an external Stereo Conversion and Display Software Application.

FIG. 8 illustrates a Block Diagram for Software Patch to enable Stereoscopic Display.

### DETAILED DESCRIPTION OF THE INVENTION

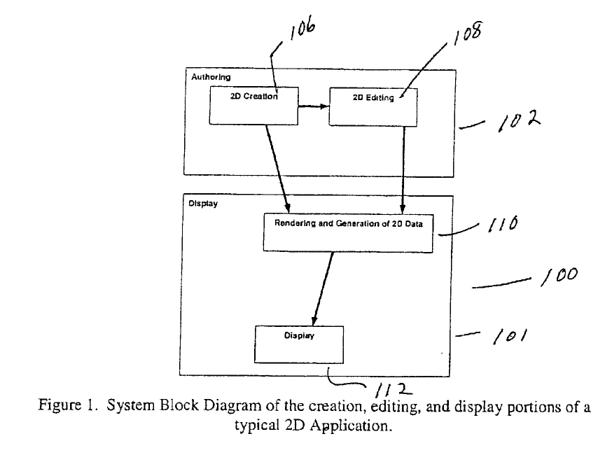

FIG. 1 illustrates a system block diagram 100 illustrating the interaction of the creation, editing, rendering and display functions in a typical 2D application. The various blocks are grouped into two categories: Authoring 102 and Display 104. The 2D creation block 106 is where 2D items and data are created (like text or graphics images in a presentation program like Power Point). The 2D Editing block 108 is where editing of the 2D item occurs. These two blocks are part of the Authoring System 102.

Once authored, a 2D item needs to be displayed. The Rendering and Generation of 2D Data block 110 is where the 2D item is converted into a form that can be displayed on a 2D display system. The display block represents the display system in use, which is typically a 2D display 112 for a standard 2D application.

In some applications, the Authoring and Display groups are contained within the same application. An example of this is Microsoft Power Point. Other applications separate the authoring and display groups. Examples of separate systems are the Macromedia Flash system for web based vector graphics. The Flash authoring application handles the authoring for Flash and the Display is handled by the Flash player application.

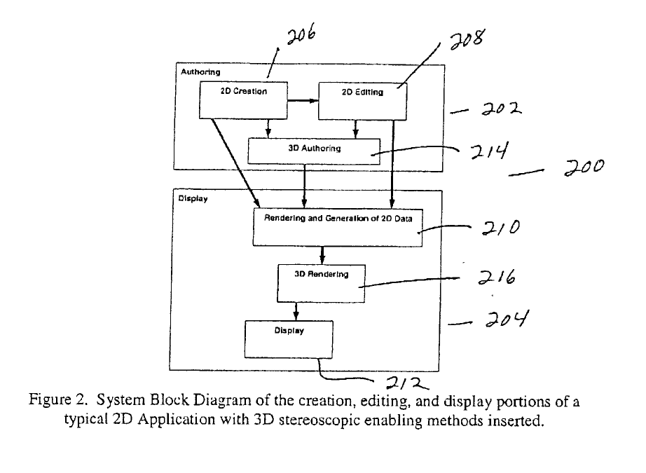

FIG. 2 illustrates the same 2D system from FIG. 1 with the addition of two blocks that constitute the 3D stereoscopic enabling system 200. The 3D Authoring block 214 is part of the Authoring group 202 and intercepts the 2D items from the 2D Creation 206 and 2D Editing Blocks 208. The 3D Authoring block 214 is where the 3D stereoscopic attributes are edited. Notice that the 3D Authoring block receives its “input” from the 2D creation and editing boxes. The user is presented with the same 2D creation and authoring functions from the original 2D application and the 3D stereoscopic features are derived from the 2D features. This illustrates how the present invention utilized the existing familiar 2D interfaces. To clarify with an example, a program like Power Point provides various objects like pictures and text. For an object like Text, the 3D Authoring block 214 will allow the user to edit specific depth locations of the object in 3D stereoscopic depth and optionally change other 3D specific parameters of the object. At anytime, the user can change the original 2D text object by using the standard editing features in the 2D Editing block 208 without making any changes through the 3D Authoring block. This capability is not provided in prior art systems.

In the Display group 204, FIG. 2 illustrates the addition of a 3D Rendering block 216 that intercepts the data from the Rendering and Generation of 2D Data block 210 and modifies the data accordingly for viewing in 3D on the display. The existing Rendering and Generation of 2D Data block 210 renders the basic 2D characteristics of the 2D item for display and only the 3D Rendering block 216 handles the 3D stereoscopic features. This allows changes to the look of the original 2D object to be preserved in the final 3D version of the item.

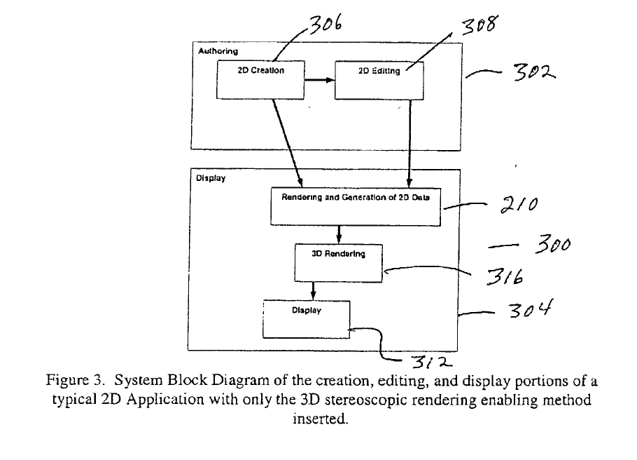

FIG. 3 illustrates a system similar to the system of FIG. 2 except that the 3D Authoring Block 214 has been removed. This illustrates another novel object of the invention where the 3D Rendering block 316 handles all the 3D stereoscopic conversion and the user does not need to use any additional 3D Authoring system. This configuration allows users to create 3D stereoscopic images without the need to learn any new 3D authoring features.

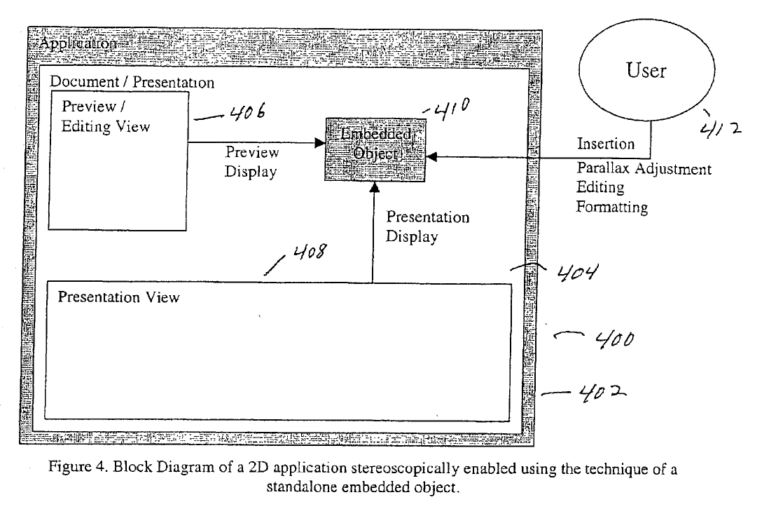

FIG. 4 illustrates a standalone embedded object technique for enabling a 2D application 402 to utilize stereoscopic content 400. The Document/Presentation Block 404 represents the document that is produced by the non-stereo-enabled software applications shown in FIGS. 2 and 3. It can contain a variety of objects such as text and images, depending on the document type.

The Document 400 and 404 (as generated by the hardware and/or software shown in FIGS. 2 and 3, 200 and 300) generally supports two modes of viewing. The first is represented by the block labeled Preview/Editing View 406 (as part of 2D Editing 208 and 308), and is responsible for displaying the document in a recognizable form while allowing the user to edit or otherwise modify the objects in the document. The second viewing mode is represented by the block labeled Presentation View 408 (as produced by the Display 212 and 312), and displays the document in its finished form to be presented or displayed. This method may be implemented in some rendered form on a computer display, or as a hardcopy printed document.

The block labeled User 412 represents the person controlling the application to create and edit the document. The User 412 interacts with the objects in the document in the Preview/Editing View 406, with the end goal of creating a presentation view to observe.

The shaded block labeled Embedded Object 410 (as part of 3D Rendering blocks 216 and 316) is the key enabling part of this scheme. It is a standalone embedded stereo object which can use any of the existing or future plug-in or object-embedding technologies, including but not limited to ActiveX, COM, or Object Linking and Embedding (OLE). Such an object can be embedded into any application that supports the hosting of the embeddable object. The embedded object is created and modified directly by the User. This includes any formatting, parallax adjustment, and other properties desired. The embedded object is able to control its own display, allowing it to render its content in whatever manner is necessary for the desired stereo viewing technique. The embedded object can be displayed in the Preview/Editing View 406, as well as in the Presentation View 408, whether these display methods be the same or are different because of the media involved.

Benefits of this method are that it uses a technology already implemented in the host application to extend its operation. This method does not seamlessly blend in with the host application.

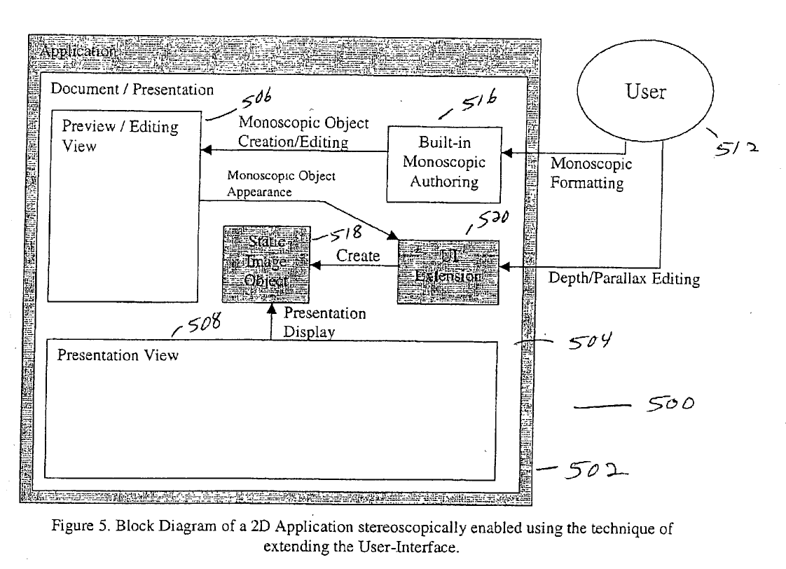

FIG. 5 illustrates using a standalone User-Interface Extension 520 (as part of 3D Rendering block 216 and 316) to stereoscopically enable 2D Application 500. In this diagram, the blocks labeled User Application 502, Document/Presentation, Preview/Editing View 506, and Presentation View 508 represent the same concepts as the similarly labeled blocks in FIG. 4.

The block labeled “Built-in Monoscopic Authoring” 516 represents the facilities for creating and modifying the standard objects of the 2D Application's Document 504 and is part of 2D Creation and 2D Editing portions of FIGS. 2 and 3 (206, 306, 208 and 308). This generally includes, but is not limited to, such devices as Toolbars, Pull-down menus, and Context Menus.

The shaded block labeled “UI Extension” 520 represents the stereoscopic enabling addition to the 2D Application produced by the 3D Rendering block 216 and 316. Such an extension can enable stereoscopic content by providing methods to convert monoscopic objects into other built-in objects that have the capability to simulate a stereo viewing technique, such as a bitmap image object. Possible methods of providing such an extension are through the Common Object Model (COM) architecture, or through the monoscopic application's Macro and/or Scripting capabilities.

The shaded block labeled “Static Image Object” 518 represents a built-in object of the host application and is also part of the 3D Rendering protein illustrated in FIGS. 2 and 3 216 and 316). This object is created in such a way as to be displayable for Stereo viewing. The user may interact with the User Interface Extension 520 directing it to replace built in monoscopic objects with built in objects that simulate stereo display techniques.

Benefits of this method are that it is slightly easier to implement. Deficiencies of this method are that it in not very dynamic. The stereoscopic image cannot always display properly in the preview mode, and this makes additional editing of the document more difficult.

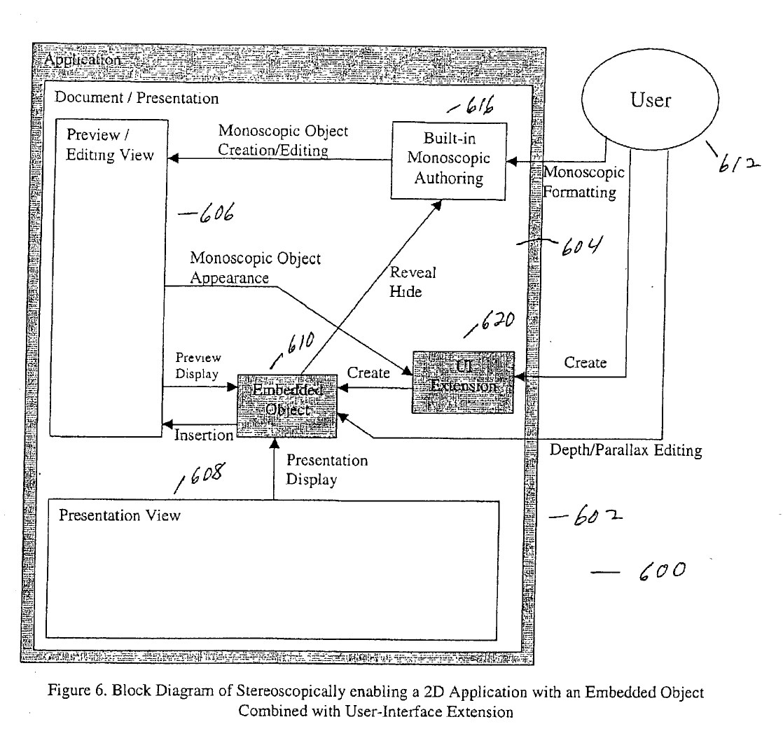

FIG. 6 illustrates a mechanism 600 that combines the two previous methods to provide greater support for stereoscopic display. In this diagram, the blocks labeled User 612, Application 602, Document/Presentation 604, Preview/Editing View 606, Presentation View 608, Built-in Monoscopic Authoring 616, Embedded Object 610, and UI Extension 620 represent the same concepts as the similarly labeled blocks in FIGS. 4 and 5 respectively.

The combination of these two methods allows the additional components to assimilate more seamlessly into the host application. The Embedded Object is able to display itself in the desired stereoscopic display technique, while receiving more dynamic input from the user via the User Interface Extension 620. Furthermore, this technique allows the stereoscopic enabling additions to be controlled and modified in a manner very similar to the original 2D objects of the unaltered software.

Benefits of this method are that it can almost seamlessly interface with the host application mimicking its original behavior with the additional stereoscopic benefits. The deficiency is that it is more complicated to implement correctly and efficiently.

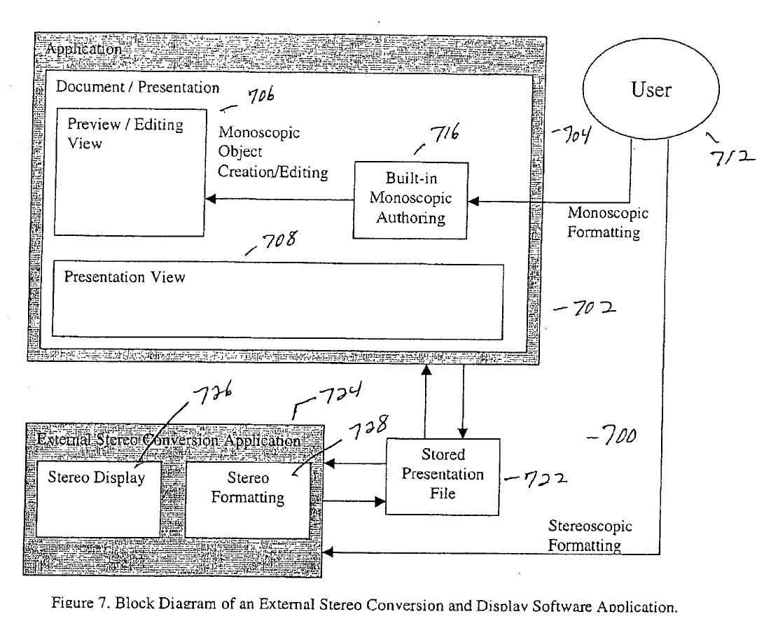

FIG. 7 illustrates a Block Diagram for an external Stereo Conversion and Display Software Application 700. In this figure, the blocks labeled User 712, Application 702, Document/Presentation 704, Preview/Editing View 706, Presentation View 708, and Built-in Monoscopic Authoring 716 represent the same concepts as the similarly labeled blocks in FIGS. 4 and 5 respectively.

The above method does not directly modify the behavior of the monoscopic host application. It consists of an External Software Application 724 that supports displaying the original monoscopic Document or Presentation in a Stereoscopic form. The external application may allow the user to adjust the depth and other properties of the document and its parts. Furthermore, the external application may allow the document or presentation to be written, or output is such a manner that it may again be displayed by the original unmodified host application in a stereo viewing technique.

The block labeled Stored Presentation File 722 represents the data that constitutes the document file as stored on any other type of media, such as but not limited to being written to a magnetic disk.

The block labeled External Stereo Conversion Application 724 represents the application that performs the actual conversion of monoscopic data into stereoscopic data. The first block contained by the External Stereo Conversion Application 724 is the Stereo Display Block 726 and performs some of the functions of 3D Rendering 216 and 316. It is responsible for displaying the original 2D Objects by some stereoscopic method. The second block, which is labeled Stereo Formatting 728 performs some of the functions of 3D Authoring 214 and 314, is interacted with by the User to specify the depth level, and other parameters having to do with stereo conversion and/or display, of each object.

The benefit of this method, is that it does not work directly in conjunction with the host application, so it can be much more stable. However, it must be able to access the original file format, requires a much larger amount of code to be written, and is less dynamic requiring a movement to another application to use.

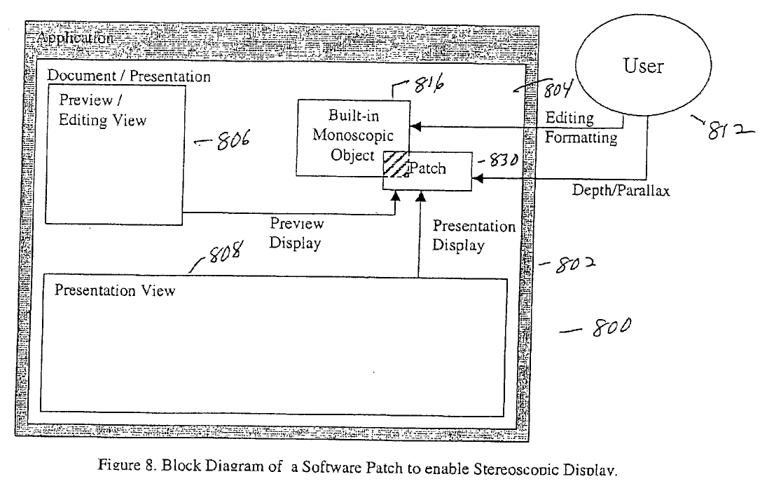

FIG. 8 illustrates a Block Diagram for Software Patch to enable Stereoscopic Display 800. In this figure, the blocks labeled User 812, Application 802, Document/Presentation 804, Preview/Editing View, and Presentation View represent the same concepts as the similarly labeled blocks in FIGS. 4 and 5 respectively.

The block labeled Built-in Monoscopic Object 816 represents some form of software that is either executed by the computer directly or otherwise interpreted. The block labeled Patch 830 represents an overlapping portion of software that replaces corresponding portions of the original 2D Application's software.

The software patch method alters the Monoscopic 816 software application by modifying the binary executable software directly to create a new hybridized application capable of handling stereoscopic content. By replacing the original logic of the application, a software patch can change the behavior of certain modules of the application so that they can display and otherwise deal with stereoscopic content and conversion.

Benefits of this method are that because it changes directly the original software, it actually becomes part of the original software and therefore achieves the ultimate seamlessness. However, it is risky to modify other vendor's software products directly, and that a patch is only likely to work on one version, requiring a complete reengineering for each new version of the host. Furthermore, patches can violate the user's license agreement for the software being patched.

The method and system described herein can be embodied in the form of computer-implemented processes and apparatuses for practicing those processes. The present method and system can also be embodied in the form of computer program code containing instructions, embodied in tangible media, such as floppy diskettes, CD-ROMs, hard drives, or any other computer-readable storage medium, wherein, when the computer program code loaded into and executed by a computer, the computer becomes an apparatus for practicing the method and system. The present method and system can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the method and system. When the implementation is on a general-purpose microprocessor, the computer program code segments configure the microprocessor to create specific logic circuits.

The apparatus and method of implementation of the 2D to 3D enabling in conjunction with a display device may be accomplished using an article of manufacture, computer program product program or program storage device having a computer usable medium having computer readable program code embodied therein for converting existing 2D applications into 3D stereoscopic compatible applications. The computer readable program code in the article of manufacture includes a computer readable program code means for 3D rendering. The article of manufacture may additionally include computer readable program code for 3D authoring. The article of manufacture may be a complete program within a computer usable medium having computer readable program code means embodied therein for converting existing 2D applications into 3D stereoscopic compatible applications. The computer readable program code in the article of manufacture includes computer readable program code for 2D creation, computer readable program code for 2D editing; computer readable program code for 3D rendering; computer readable program code for rendering and generation of 2D data; and computer readable program code for 3D rendering. This article of manufacture further includes computer readable program code for 3D authoring.

The embodiments described are merely exemplary. It is understood that other embodiments will readily occur to person with ordinary skill in the art. All such modifications and variations are deemed to be within the scope and spirit of the present invention as defined by the accompanying claims.

We claim:

1. An apparatus for enabling a monoscopic system having an authoring sun-system: comprising a 2D creation subsystem and a 2D editing subsystem; and a 2D display subsystem having a 2D data rendering and generation subsystem and a display sub-system to support 3D stereoscopic imaging comprising:
a 3D rendering subsystem.

2. The apparatus of claim 1 further comprising a 3D authoring sub-system

3. The apparatus of claim 1 wherein a 2D document/presentation having a preview/editing view and a presentation view are 3D by an embedded object controlled by a user and uses data from a preview display and a presentation display.

4. The apparatus of claim 2 wherein said user may insert parallax adjustments, editing and/or formatting 3D stereoscopic enablements.

5. The apparatus of claim 3 wherein said user may insert monoscopic formatting and depth/parallax editing data.

6. An article of manufactures comprising:
a computer usable medium having computer readable program code means embodied therein for converting existing 2D applications into 3D stereoscopic compatible applications, the computer readable program code means in the article of manufacture comprising:
computer readable program code means for 3D rendering.

7. The article of manufacture of claim 6 wherein said computer usable medium further comprises:
computer readable program code means for 3D authoring.

8. An article of manufacture comprising:
a computer usable medium having computer readable program code means embodied therein for converting existing 2D applications into 3D stereoscopic compatible applications, the computer readable program code means in the article of manufacture comprising:
computer readable program code means for 2D creation;
computer readable program code means for 2D editing;
computer readable program code means for code means for 3D rendering;
computer readable program code means for rendering and generation of 2D data;
computer readable program code means for 3D rendering.

9. The article of manufacture of claim 8 wherein said computer usable medium further comprises:
computer readable program code means for 3D authoring.

10. A computer program product comprising:
a computer usable medium having computer readable program code means embodied therein for converting 2D applications into 3D stereoscopic compatible applications, the computer readable program code means in the article of manufacture comprising:
computer readable program code means for rendering

11. The article of manufacture of claim 10 wherein said computer usable medium further comprises:
computer readable program code means for 3D authoring.

12. A computer program product comprising:
a computer usable medium having computer readable program code means embodied therein for converting existing 2D applications into 3D stereoscopic compatible applications, the computer readable program code means in the article of manufacture comprising:
computer readable program code means for 2D creation;
computer readable program code means for 2D editing;
computer readable program code means for code means for 3D rendering;
computer readable program code means for rendering and generation of 2D data;
computer readable program code means for 3D rendering.

13. The article of manufacture of claim 12 wherein said computer usable medium further comprises:
computer readable program code means for 3D authoring.

13. A program storage device readable by a machine, tangibly embodying a program of instructions executable by the machine to perform method steps for converting existing 2D applications into 3D compatible applications the method step comprising:
performing 3D rendering.

14. The article of manufacture of claim 13 wherein said method further comprises:
performing 3D authoring.
